(19) United States
(12) Patent Application Publication
(10) Pub. No.: US 2004/0202417 A1
(43) Pub. Date: Oct. 14, 2004

(54) Optical monitor device

(75) Inventors: Tetsuo Watanabe, Kawasaki (JP); Toshiya Kishida, Kawasaki (JP); Takashi Yamane, Kawasaki (JP); Tatsuro Kunikane, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/747,245

(22) Filed: Dec. 30, 2003

(30) Foreign Application Priority Data
Jan. 10, 2003 (JP) 2003-004112

(51) Int. Cl. G02B 6/32; G02B 6/26

(52) U.S. Cl. 385/33; 385/31

(57) ABSTRACT

There provided a small low-cost optical monitor device. In this optical monitor device, input fibers and output fibers are arranged in an array on one side, first lenses are arranged in an array on the optic axes of input optical signals outputted from the input fibers, and second lenses are arranged in an array on the optic axes of output optical signals inputted to the output fibers. Input optical signals is inputted to a coupler film via the first lenses and optical signals which pass through the coupler film will be detected by front incidence type PD elements. On the other hand, output optical signals reflected from the coupler film are inputted to the second lenses separate from the first lenses, from which the input optical signals were outputted, and are coupled to the corresponding output fibers. As a result, a reflection and loop back structure is realized. In this reflection and loop back structure, a plurality of input optical signals are reflected accurately by a coupler film and are outputted. Therefore, an optical monitor device can be miniaturized. In addition, by using generally available members, the costs of an optical monitor device can be reduced.

### BACKGROUND OF THE INVENTION

(1) Field of the Invention

This invention relates to an optical monitor device and, more particularly, to an optical monitor device included in, for example, an optical transmission unit for detecting the intensity, polarization, and the like of an optical signal and for feeding back obtained results to other parts.

(2) Description of the Related Art

With an increase in traffic on the Internet, in recent years there have been intense demands for an increase in optical communication capacity in optical communication systems. To satisfy these demands, an increase in optical communication capacity, for example, by the method of increasing a transfer rate or by a wavelength division multiplex (WDM) system has been examined. Accordingly, the development of optical devices for smoothly operating optical communication systems in which the above method or system is adopted is being hastened. With WDM transmission units, for example, an optical monitor device having the function of detecting the intensity, polarization, and the like of an optical signal and feeding back obtained results to each of other parts included in them is necessary.

Currently, with many WDM transmission units, a monitoring function is realized by placing a photodiode (PD) element before or behind each part. However, with the above WDM transmission units in which a PD element is placed for each part, an increase in the number of wavelengths handled, that is to say, in the number of channels will result in much mount space or a high cost. Therefore, in recent years optical monitor devices in which parts and members are arranged in an array have been developed actively. For example, an optical monitor device having a structure shown in FIG. 12, 13, or 14 is proposed.

FIGS. 12(A) and 12(B) are views showing an example of the structure of an optical monitor device in which small PD modules are arranged. FIG. 12(A) is a plan of the feature of the optical monitor device. FIG. 12(B) is a side view of the feature of the optical monitor device. An optical monitor device 100 shown in FIGS. 12(A) and 12(B) has a structure in which small PD modules 101 containing a PD element are arranged in a package 102. An input port 103 and an output port 104 are connected to each small PD module 101 from one side. In addition, an electric terminal 105 electrically connected to other individual parts is formed on each small PD module 101 and is drawn from the package 102 to the outside. In the optical monitor device 100 having this structure, part of an optical signal inputted from the input port 103 passes through a reflection board or the like (not shown), which will function as a half mirror, and is converted photoelectrically by the PD element in the small PD module 101. An electrical signal obtained is fed back from the electric terminal 105 to a predetermined part connected to the small PD module 101. The rest of the optical signal inputted from the input port 103 does not pass through the reflection board, is reflected from it, and is outputted from the output port 104.

Conventionally, several propositions are made on such a small PD module, including the one having a structure in which an inputted optical signal is amplified, is made to branch, and is monitored by a PD element (see, for example, Japanese Unexamined Patent Publication No. 7-64021 and Japanese Unexamined Patent Publication No. 7-301763).

FIGS. 13(A) and 13(B) are views showing an example of the structure of an optical monitor device using a planar lightwave circuit. FIG. 13(A) is a plan of the feature of the optical monitor device. FIG. 13(B) is a side view of the feature of the optical monitor device. An optical monitor device 200 shown in FIGS. 13(A) and 13(B) includes a planar lightwave circuit (PLC) 202 in a package 201. Two tape fibers opposite to each other with the PLC 202 between are used as an input port 203 and an output port 204 respectively. A PD element 205 is placed in the PLC 202. Electric terminals 206 are drawn from the package 201 to the outside. In the optical monitor device 200 having this structure, part of an optical signal propagating through the PLC 202 will be detected by the PD element 205.

FIGS. 14(A) and 14(B) are views showing an example of the structure of an optical monitor device using a coupler. FIG. 14(A) is a plan of the feature of the optical monitor device. FIG. 14(B) is a side view of the feature of the optical monitor device. An optical monitor device 300 shown in FIGS. 14(A) and 14(B) includes tape fibers, which are opposite to each other, each of which is fixed by a fiber fixing block 302 in a package 301, and which are used as an input port 303 and an output port 304 respectively. Lenses 305a and 305b, a coupler 306, and a PD element 307 are located between the input port 303 and the output port 304. Electric terminals 308 are drawn from the package 301 to the outside. In the optical monitor device 300 having this structure, an optical signal inputted from the input port 303 is concentrated by the lens 305a, part of it is detected by the PD element 307 by making use of reflection from the coupler 306, and the rest of it is concentrated by the lens 305b and is outputted from the output port 304.

With the optical monitor devices having the conventional structures, however, the following problems still exist.

First, with the optical monitor device in which small PD modules are arranged in an array, one small PD module is placed for each channel. Accordingly, an increase in the number of channels will result in a high cost and put a limit on its miniaturization. With the optical monitor device using a PLC, light leakage in the PLC may make it impossible to prevent cross talk between channels. Furthermore, if the fibers are opposite to each other, they will extend from both ends of the optical monitor device. This may cause the problem of space for mounting them.

### SUMMARY OF THE INVENTION

The present invention was made under the background circumstances as described above. An object of the present invention is to provide a small optical monitor device which can be fabricated at a low cost and which can detect an optical signal with great accuracy.

In order to achieve the above object, an optical monitor device for detecting the intensity of an optical signal propagating through a fiber is provided. This optical monitor device comprises a plurality of fibers which are arranged in an array and through which optical signals propagate, lenses arranged in an array on the optic axes of optical signals propagating through the plurality of fibers, a coupler film for transmitting part of an optical signal inputted via any one of the lenses and for reflecting the rest of the optical signal into another lens, and photodetectors arranged on the optic axes of optical signals which pass through the coupler film.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 is a perspective view for describing the feature of the structure of an optical monitor device according to a first embodiment of the present invention.

FIG. 2 is a side view for describing the feature of the structure of the optical monitor device according to the first embodiment of the present invention.

FIGS. 3(A), 3(B) and 3(C) are views for describing a case where the electrode of a PD element is formed by the use of both surfaces of a PD submount, FIG. 3(A) being a side view of a feature, FIG. 3(B) being a plan of the feature, and FIG. 3(C) being a rear view of the feature.

FIGS. 4(A), 4(B) and 4(C) are views for describing a case where the electrode of a PD element is formed only on one surface of a PD submount, FIG. 4(A) being a side view of a feature, FIG. 4(B) being a plan of the feature, and FIG. 4(C) being a rear view of the feature.

FIG. 5 is a side view for describing the feature of the structure of an optical monitor device according to a second embodiment of the present invention.

FIG. 6 is a side view for describing the feature of the structure of an optical monitor device according to a third embodiment of the present invention.

FIG. 7 is a side view for describing the feature of the structure of an optical monitor device according to a fourth embodiment of the present invention.

FIG. 8 is a side view for describing the feature of the structure of an optical monitor device according to a fifth embodiment of the present invention.

FIG. 9 is a side view for describing the feature of the structure of an optical monitor device according to a sixth embodiment of the present invention.

FIG. 10 is a side view for describing the feature of the structure of an optical monitor device according to a seventh embodiment of the present invention.

FIGS. 11(A) and 11(B) are views showing an example of how to house an optical monitor device in a package, FIG. 11(A) being a plan of a feature, FIG. 11(B) being a side view of the feature.

FIGS. 12(A) and 12(B) are views showing an example of the structure of an optical monitor device in which small PD modules are arranged, FIG. 12(A) being a plan of the feature of the optical monitor device, FIG. 12(B) being a side view of the feature of the optical monitor device.

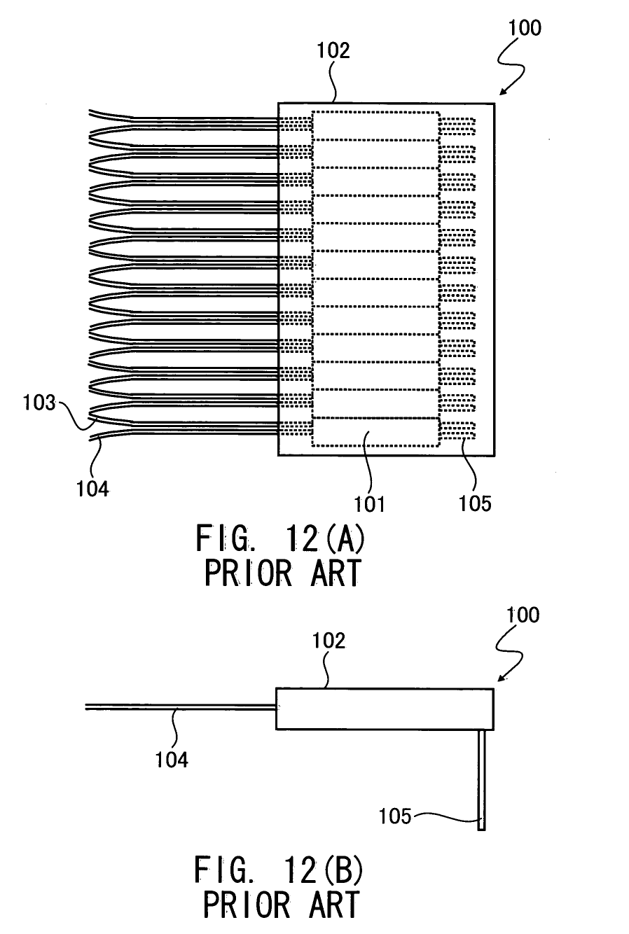

FIGS. 13(A) and 13(B) are views showing an example of the structure of an optical monitor device using a planar lightwave circuit, FIG. 13(A) being a plan of the feature of the optical monitor device, FIG. 13(B) being a side view of the feature of the optical monitor device.

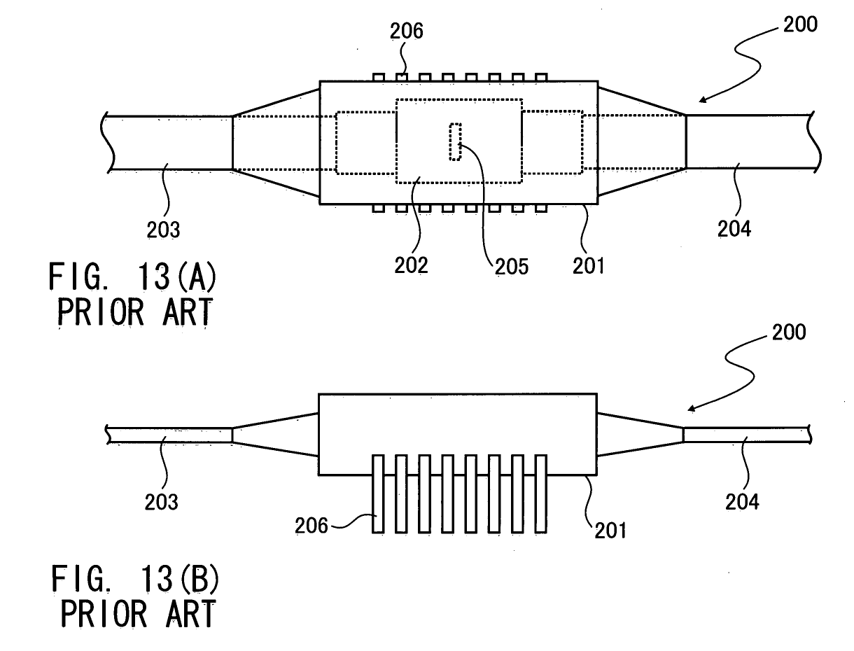

FIGS. 14(A) and 14(B) are views showing an example of the structure of an optical monitor device using a coupler, FIG. 14(A) being a plan of the feature of the optical monitor device, FIG. 14(B) being a side view of the feature of the optical monitor device.

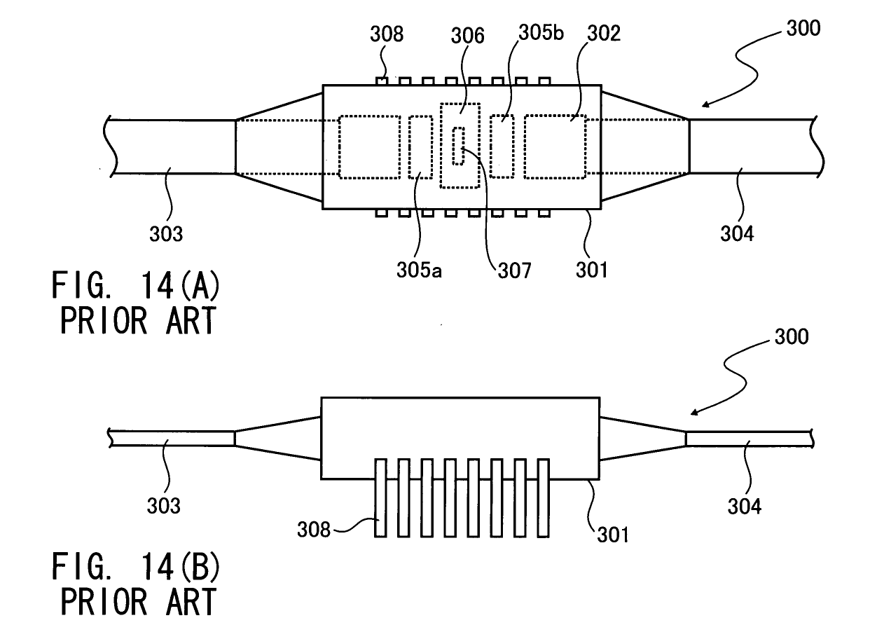

### DESCRIPTION OF THE PREFERRED EMBODIMENTS

Embodiments of the present invention will now be described in detail with reference to the drawings.

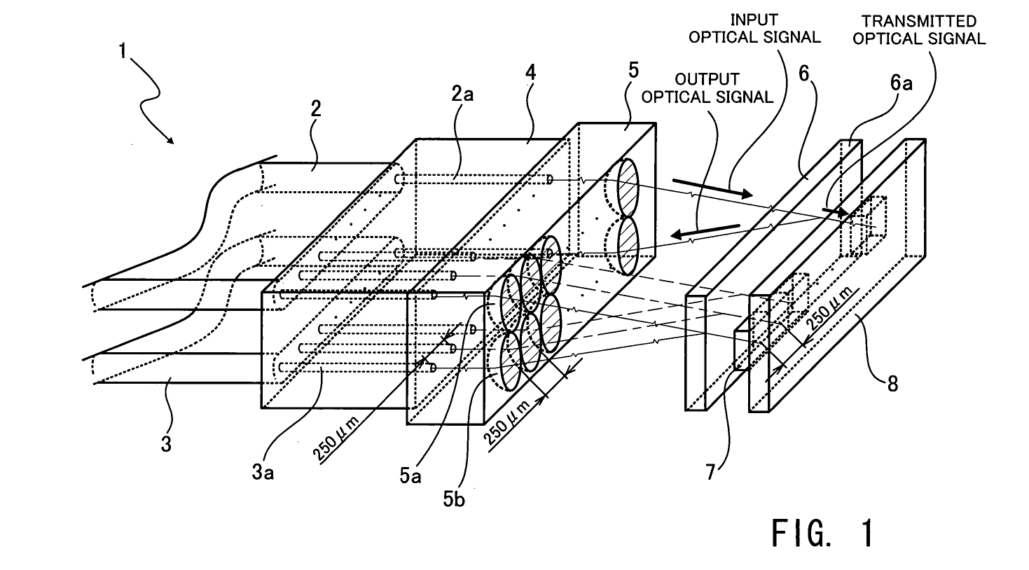

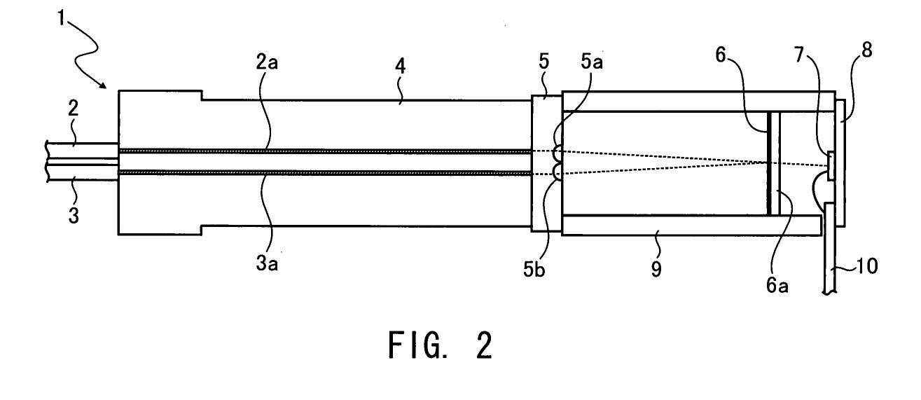

A first embodiment of the present invention will be described first. FIG. 1 is a perspective view for describing the feature of the structure of an optical monitor device according to a first embodiment of the present invention. FIG. 2 is a side view for describing the feature of the structure of the optical monitor device according to the first embodiment.

An optical monitor device 1 shown in FIGS. 1 and 2 includes an input port 2, an output port 3, a fiber arrangement member 4, an array lens 5, a coupler film 6, front incidence type PD elements 7, and a PD submount 8. As shown in FIG. 2, spaces and the components between the array lens 5 and the PD submount 8 are shielded from the outside by a case 9, which is not shown in FIG. 1.

Multi-core tape fibers are used as the input port 2 and the output port 3 in the optical monitor device 1. For example, ordinary twelve-core tape fibers which can input or output optical signals corresponding to twelve channels can be used. In this example, twelve-core tape fibers are used and a pitch between input fibers 2a and a pitch between output fibers 3a are about 250 μm. As shown in FIGS. 1 and 2, the tape surfaces of the input port 2 and the output port 3 are opposite to each other. The input port 2 and the output port 3 are fixed to the upper and lower areas, respectively, of a surface of the fiber arrangement member 4 by the use of, for example, an epoxy optical adhesive. The input fibers 2a and output fibers 3a are arranged in a fixed state in the fiber arrangement member 4 so that their tips will pierce through the fiber arrangement member 4.

The array lens 5 is bonded to the surface of the fiber arrangement member 4 where the tips of the input fibers 2a and output fibers 3a reach by the use of, for example, an optical adhesive. In the array lens 5, lenses 5a are formed on the optic axes of optical signals which are outputted from the tips of the input fibers 2a after being inputted from the input port 2 (as input optical signals), and lenses 5b are formed on the optic axes of optical signals which are outputted from the output port 3 (as output optical signals) after being inputted from the tips of the output fibers 3a. That is to say, in the array lens 5, twelve lenses 5a corresponding to the input fibers 2a are formed in a row in the upper area and twelve lenses 5b corresponding to the output fibers 3a are formed in a row in the lower area. Accordingly, a total of 24 lenses are formed in an array.

Usually the lenses 5a and 5b arranged in an array are formed as collimating lenses or condensing lenses by changing the composition of only areas in a lens base material, such as glass, where these lenses are to be formed to predetermined composition by, for example, ion exchange. In this example, the lenses 5a and 5b are hemispherical collimating lenses with a convex surface on the fiber arrangement member 4 side and a flat surface having a diameter of about 250 μm on the other side and are formed adjacently to one another. In this case, the distance between the centers of the flat surfaces of adjacent lenses 5a and between the centers of the flat surfaces of adjacent lenses 5b are about 250 μm and the distance between the centers of the flat surfaces of adjacent lenses 5a and 5b (gap between input and output lenses) is also about 250 μm.

As stated above, if a gap between input and output lenses in the array lens 5 is set to about 250 μm, then in FIG. 1 or 2 the distance between an input fiber 2a and an output fiber 3a placed just beneath it (gap between input and output fibers) will be set to a value greater than that of the gap between input and output lenses. For example, the gap between input and output fibers is set to about 300 μm. In this case, the optic axis of an input optical signal inputted from the input fiber 2a to a lens 5a will shift by about 25 μm from the center of the convex surface of the lens 5a in the direction of the outside of the optical monitor device 1. In addition, the optic axis of an output optical signal inputted to the output fiber 3a will shift by about 25 μm from the center of the convex surface of a lens 5b in the direction of the outside of the optical monitor device 1.

The coupler film 6 is formed on a transparent substrate 6a of, for example, glass, which is supported by the case 9 shown in FIG. 2, at a certain distance from the array lens 5. The coupler film 6 transmits part of an input optical signal and reflects the rest of it as an output optical signal. A dielectric multilayer film formed so as to have a certain reflection factor can be used as the coupler film 6. The array lens 5 is placed so that its focus will be on the coupler film 6. By doing so, part of an input optical signal inputted via a lens 5a in the upper area of the array lens 5 is reflected by the coupler film 6 and is inputted to a lens 5b just beneath the lens 5a as an output optical signal. In this example, the coupler film 6 is placed at a distance of about 5 mm from the end surface of the array lens 5. In the optical monitor device 1 according to the first embodiment, there is air in the area between the array lens 5 and the coupler film 6 where an optical signal propagates.

Part of each input optical signal inputted to the coupler film 6 via a lens 5a will pass through the coupler film 6. A photodetector is placed on the optic axis of the transmitted optical signal so that the transmitted optical signal will be inputted to its optical signal receiving section. In this example, the front incidence type PD elements 7 are used as photodetectors. Like the above twelve lenses 5a, the front incidence type PD elements 7 are arranged in a row on the PD submount 8. Accordingly, the distance between the optical signal receiving sections of adjacent front incidence type PD elements 7 is about 250 μm. The front incidence type PD elements 7 are arranged in advance in predetermined positions on the PD submount 8 and are connected to electric terminals 10, respectively, for sending other parts detection results. However, the electric terminals 10 are not shown in FIG. 1.

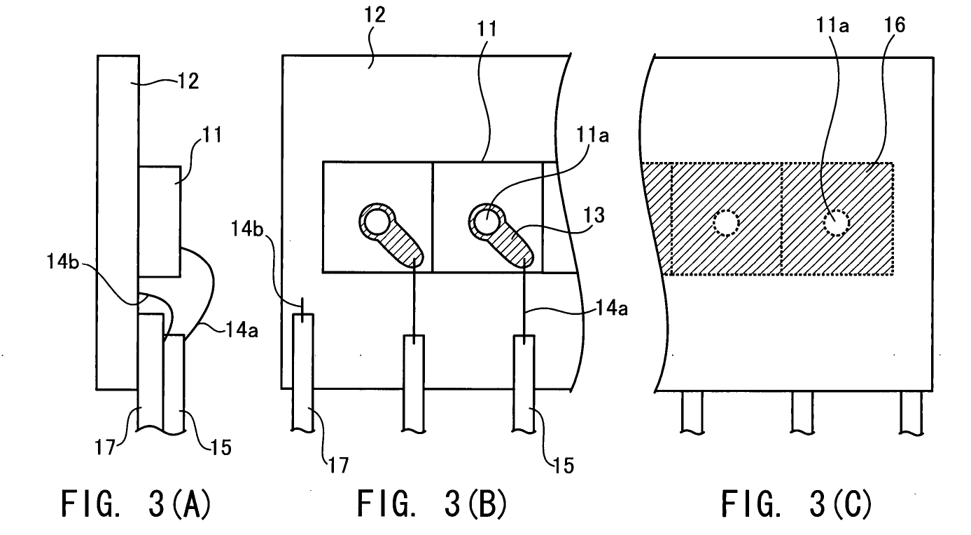

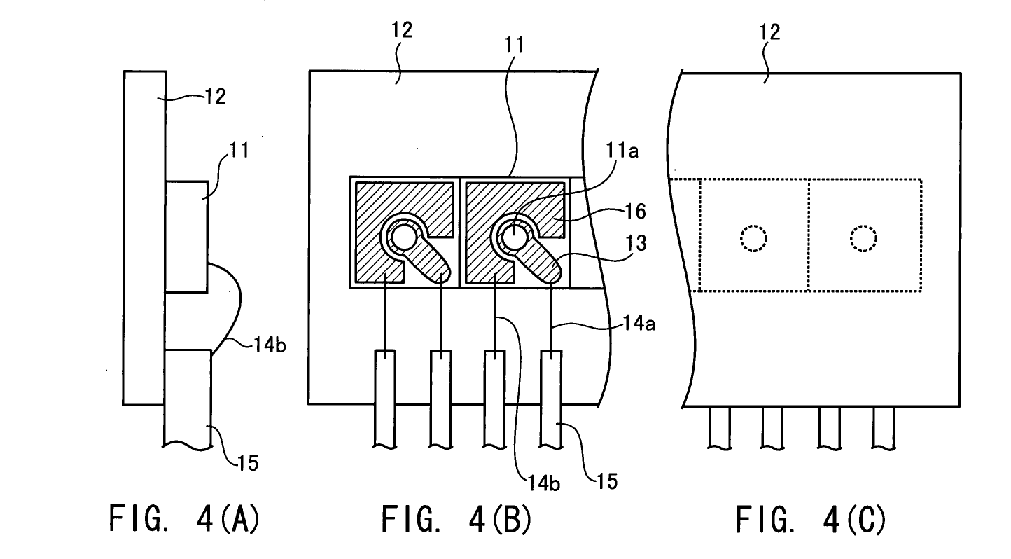

The structure of the electrode of a PD element used in an optical monitor device will now be described with reference to FIGS. 3 and 4. FIGS. 3(A), 3(B) and 3(C) are views for describing a case where the electrode of a PD element is formed by the use of both surfaces of a PD submount. FIG. 3(A) is a side view of a feature. FIG. 3(B) is a plan of the feature. FIG. 3(C) is a rear view of the feature. FIGS. 4(A), 4(B) and 4(C) are views for describing a case where the electrode of a PD element is formed only on one surface of a PD submount. FIG. 4(A) is a side view of a feature. FIG. 4(B) is a plan of the feature. FIG. 4(C) is a rear view of the feature. In FIGS. 3 and 4, components having the same function will be marked with the same reference numerals.

First, PD elements 11 are arranged in predetermined positions on a PD submount 12 by sticking with, for example, an epoxy optical adhesive. As shown in FIGS. 3(A) and 3(B), if the electrode of each PD element 11 is formed by the use of both surfaces of the PD submount 12, a P electrode 13 is formed around an optical signal receiving section 11a on its top surface as a first electrode. The P electrode 13 is connected to an electric terminal 15 by a gold wire 14a. On the other hand, as shown in FIG. 3(C), an N electrode 16 as a second electrode is formed in an area, excluding an optical signal receiving section 11a area, on the back of the PD submount 12 corresponding to each PD element 11. Moreover, as shown in FIGS. 3(A) and 3(B), a COM terminal 17 connected to the N electrodes 16 by a gold wire 14b is formed on the surface of the PD submount 12 where the PD elements 11 are arranged.

As shown in FIGS. 4(A) and 4(B), if the electrode of each PD element 11 is formed only on one surface of the PD submount 12, a P electrode 13 is formed around an optical signal receiving section 11a on its top surface and an N electrode 16 is formed around the P electrode 13. The P electrode 13 and N electrode 16 are connected to electric terminals 15 by gold wires 14a and 14b respectively. Therefore, as shown in FIG. 4(C), in this case, no electrode will be formed on the back of the PD submount 12 where the PD elements 11 are not arranged.

The PD elements 11 shown in FIGS. 3 and 4 may be of a front incidence type or a back incidence type. With the optical monitor device according to the present invention, one of the above electrode structures can be selected properly according to its structure.

In the optical monitor device 1 having the above structure, an input optical signal inputted to the input port 2 is outputted from the tip of the input fiber 2a and is inputted to the lens 5a. The position on the lens 5a where this input optical signal is inputted will be off the center of the convex surface in the direction of the outside of the optical monitor device 1 because the gap between input and output fibers is greater than the gap between input and output lenses. The input optical signal inputted to this position on the lens 5a is refracted and its travel direction is changed. Then the input optical signal is inputted to the coupler film 6 at a certain incident angle. Part of the input optical signal passes through the coupler film 6 and the rest of it is reflected from the coupler film 6 and becomes an output optical signal.

The output optical signal reflected at a reflection angle corresponding to the incident angle at which the input optical signal was inputted to the coupler film 6 is inputted to a lens 5b in the lower area of the array lens 5 adjacent to the lens 5a in the upper area from which the input optical signal was outputted at a certain incident angle to its flat surface. The output optical signal inputted to the lens 5b will be outputted from the convex surface of the lens 5b. The position on the lens 5b where the output optical signal is outputted will be off the center of its convex surface in the direction of the outside of the optical monitor device 1. Accordingly, the travel direction of the output optical signal is changed and it will be coupled to an output fiber 3a.

On the other hand, the transmitted optical signal which passed through the coupler film 6 is inputted to a front incidence type PD element 7 placed on its optic axis and is photoelectrically converted there. An electrical signal (current value) obtained will be sent to each of other parts via an electric terminal 10 on the PD submount 8.

As stated above, with the optical monitor device 1, a reflection and loop back structure is realized. That is to say, an input optical signal inputted to the input port 2 and outputted from each input fiber 2a is reflected accurately by the coupler film 6, is coupled to the corresponding output fiber 3a, and is outputted to the output port 3 placed on the same side as the input port 2. To realize this structure, the arrangement of each member, such as a gap between input and output lenses, a gap between input and output fibers, and the distance between the array lens 5 and the coupler film 6, included in the optical monitor device 1 is determined optimally and optical paths are adjusted.

As described above, the optical monitor device 1 according to the first embodiment of the present invention has the following structure. On one side of the optical monitor device 1, two multi-core tape fibers are placed with one over the other. Members, such as the array lens 5 and the front incidence type PD elements 7, are arranged in an array in the direction of the other side. By placing the coupler film 6 before the front incidence type PD elements 7, each input optical signal is reflected, is turned back, and is outputted. Such a reflection and loop back structure will enable miniaturization of the optical monitor device 1. Furthermore, standard members already marketed can be used as the multi-core tape fibers and the array lens 5 included in the optical monitor device 1. As a result, compared with conventional optical monitor devices, the unit cost per channel of the optical monitor device 1 can be reduced significantly. That is to say, the optical monitor device 1 can be fabricated at a low cost.

With the optical monitor device 1 in the above example, a gap between input and output lenses is about 250 μm and a gap between input and output fibers is about 300 μm. However, the value of a gap between input and output lenses is not limited to it. If the same optical system that is used in the above example can be realized, a gap between input and output lenses, a gap between input and output fibers, the distance between the array lens 5 and the coupler film 6, or the like can be changed properly.

In addition, in the above example, two twelve-core tape fibers are placed with one over the other and their tape surfaces are opposite to each other. However, a generally available twenty-four-core tape fiber with twelve cores in the upper area and twelve cores in the lower area may be used. It is a matter of course that twenty-four discrete fibers may be arranged to form the above array.

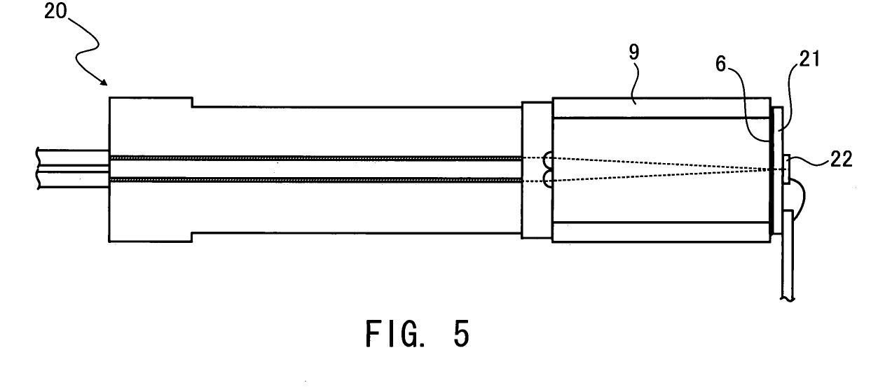

Now, a second embodiment of the present invention will be described. FIG. 5 is a side view for describing the feature of the structure of an optical monitor device according to a second embodiment of the present invention. Components in FIG. 5 which are the same as those shown in FIG. 2 will be marked with the same reference numerals and detailed descriptions of them will be omitted.

An optical monitor device 20 according to the second embodiment of the present invention shown in FIG. 5 differs from the optical monitor device 1 according to the first embodiment of the present invention in that a coupler film 6 is formed on one surface of a PD submount 21 of, for example, transparent glass which also functions as the transparent substrate 6a shown in FIG. 2 and in that back incidence type PD elements 22 are arranged in an array on the other surface of the PD submount 21 as photodetectors. In this case, electrodes formed directly on the top surfaces of the back incidence type PD elements 22 or the whole of the back incidence type PD elements 22 including these electrodes and gold wires is sealed by the use of, for example, a known molded resin. This is not shown in FIG. 5. The rest of the structure of the optical monitor device 20 is the same as that of the optical monitor device 1 according to the first embodiment of the present invention.

In the optical monitor device 20, the back incidence type PD elements 22 are arranged in a row on the optic axes of optical signals which pass through the coupler film 6 on a surface of the PD submount 21 where the coupler film 6 is not formed. This is the same with the front incidence type PD elements 7 shown in FIG. 2. In this case, the electrodes of the back incidence type PD elements 22 should have the structure shown in FIG. 4. In the optical monitor device 20 using the back incidence type PD elements 22, an optical signal which passed through the coupler film 6 passes through the PD submount 21 and is inputted to an optical signal receiving section of the back incidence type PD element 22 placed on its optic axis and its intensity is detected.

As stated above, by arranging the coupler film 6 and the back incidence type PD elements 22 on the PD submount 21, the structure of the optical monitor device 20 can be simplified and, compared with a case where front incidence type PD elements are used, the optical monitor device 20 can be miniaturized.

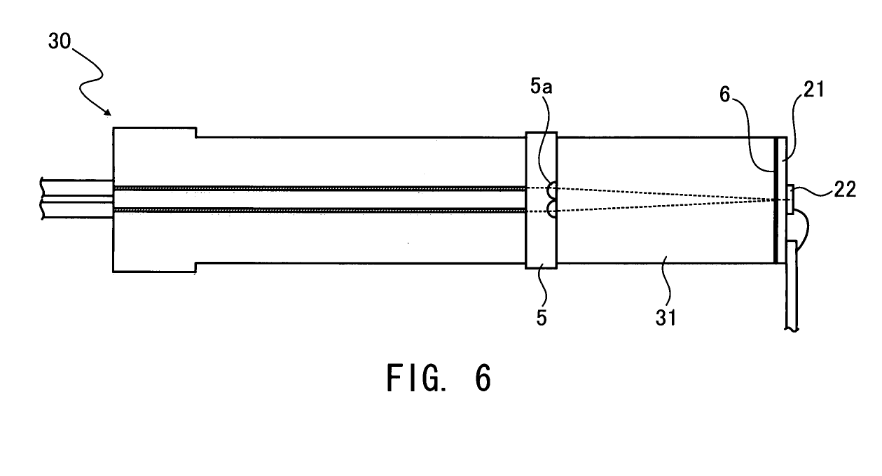

Now, a third embodiment of the present invention will be described. FIG. 6 is a side view for describing the feature of the structure of an optical monitor device according to a third embodiment of the present invention. Components in FIG. 6 which are the same as those shown in FIGS. 2 and 5 will be marked with the same reference numerals and detailed descriptions of them will be omitted.

An optical monitor device 30 according to the third embodiment of the present invention shown in FIG. 6 differs from the optical monitor device 20 according to the second embodiment of the present invention in that an array lens 5 and a PD submount 21 on one surface of which a coupler film 6 is formed are fixed to a transparent member 31 by the method of, for example, glueing instead of using the case 9 shown in FIG. 5. A transparent solid medium the physical properties of which are the same as or similar to those of, for example, the array lens 5 will be used as the transparent member 31. The rest of the structure and operating principles of the optical monitor device 30 are the same as those of the optical monitor device 20 according to the second embodiment of the present invention.

In the optical monitor device 30 using the above transparent member 31, an optical signal outputted from a lens 5a will propagate through the transparent member 31 until it reaches the coupler film 6. Accordingly, an optical signal will not propagate through the air in the area between the array lens 5 and the coupler film 6. This improves the characteristics of return loss. Moreover, an optical path will not be blocked off by dust or the like in this area and a stable optical system can be realized.

In the optical monitor device 30 according to the third embodiment of the present invention, the coupler film 6 is formed on the PD submount 21. However, the coupler film 6 and the transparent member 31 may be united by forming the coupler film 6 on the end of the transparent member 31. In addition, back incidence type PD elements 22 are used in the optical monitor device 30. However, even if front incidence type PD elements are used, a transparent member can be used as in the optical monitor device 30 according to the third embodiment of the present invention. For example, given the structure of the optical monitor device 1 shown in FIG. 2, a transparent member should be placed between the array lens 5 and the coupler film 6 instead of using the case 9. By doing so, the same effects, including the improvement of the characteristics of return loss and the prevention of the blocking off of an optical path, that are described above will be obtained.

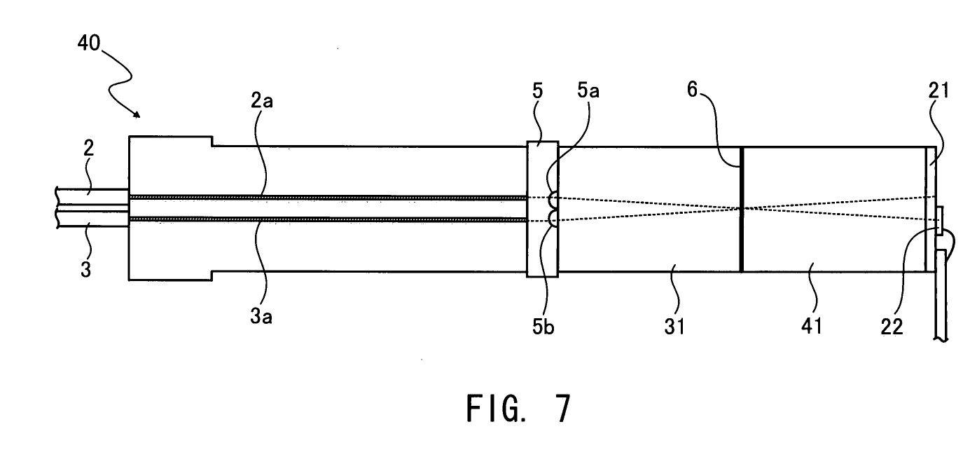

Now, a fourth embodiment of the present invention will be described. FIG. 7 is a side view for describing the feature of the structure of an optical monitor device according to a fourth embodiment of the present invention. Components in FIG. 7 which are the same as those shown in FIGS. 2, 5, and 6 will be marked with the same reference numerals and detailed descriptions of them will be omitted.

An optical monitor device 40 according to the fourth embodiment of the present invention shown in FIG. 7 differs from the optical monitor device 30 according to the third embodiment of the present invention in that transparent members 31 and 41 are placed between an array lens 5 and a coupler film 6 and between the coupler film 6 and a PD submount 21 respectively. A transparent solid medium the physical properties of which are the same as or similar to those of, for example, the array lens 5 will be used as the transparent member 41. The coupler film 6 is formed on one surface of the transparent member 41 by vacuum evaporation and the PD submount 21 is fixed to the other surface of the transparent member 41 by the method of, for example, glueing. The transparent member 31 is fixed by the method of, for example, glueing to the surface of the transparent member 41 where the coupler film 6 is formed. The rest of the structure of the optical monitor device 40 is the same as that of the optical monitor device 30 according to the third embodiment of the present invention.

In the optical monitor device 40 having the above structure, an input optical signal outputted from an input fiber 2a via a lens 5a propagates through the transparent member 31. When the input optical signal reaches the coupler film 6, part of it passes through the coupler film 6 and the rest of it is reflected by the coupler film 6 as an output optical signal. The input optical signal which passed through the coupler film 6 propagates further through the transparent member 41, is inputted to a back incidence type PD element 22, and is detected. On the other hand, the output optical signal propagates through the transparent member 31 and is coupled to an output fiber 3a via a lens 5b.

It is assumed that an optical signal is inputted to an output port 3 and that this optical signal is outputted from the output fiber 3a. In this case, the optical signal outputted from the output fiber 3a via the lens 5b propagates through the transparent member 31 and is reflected by the coupler film 6. Part of the optical signal inputted to the coupler film 6 passes through it and propagates further through the transparent member 41. In the optical monitor device 40, however, if the distance an optical signal travels in the transparent member 41 is greater than or equal to a certain value, then the back incidence type PD element 22 will not be on the optic axis of an optical signal which is outputted from the output fiber 3a and which passes through the coupler film 6. As a result, the intensity of an optical signal inputted from the output port 3 will not be detected. As stated above, locating the coupler film 6 between the two transparent members 31 and 41 will increase the distance from the coupler film 6 to the back incidence type PD element 22. Therefore, only optical signals inputted from an input port 2 can be selected and detected from among optical signals which pass through the coupler film 6. That is to say, the optical monitor device 40 having excellent directivity can be realized.

With the optical monitor device 40 according to the fourth embodiment of the present invention, the PD submount 21 is bonded and fixed to the transparent member 41. However, the back incidence type PD elements 22 and their appendant electrode structures may be formed directly on the transparent member 41 by, for example, the method shown in FIG. 4. Moreover, with an optical monitor device using front incidence type PD elements, the same structure that is used in the optical monitor device 40 according to the fourth embodiment of the present invention can be adopted. In this case, in, for example, the optical monitor device 1 shown in FIG. 2, the coupler film 6 should be located between two transparent members in the case 9 of moderate size and the PD submount 8 on which the front incidence type PD elements 7 are arranged should be located behind the case 9. By doing so, the same effect that is described above will be obtained.

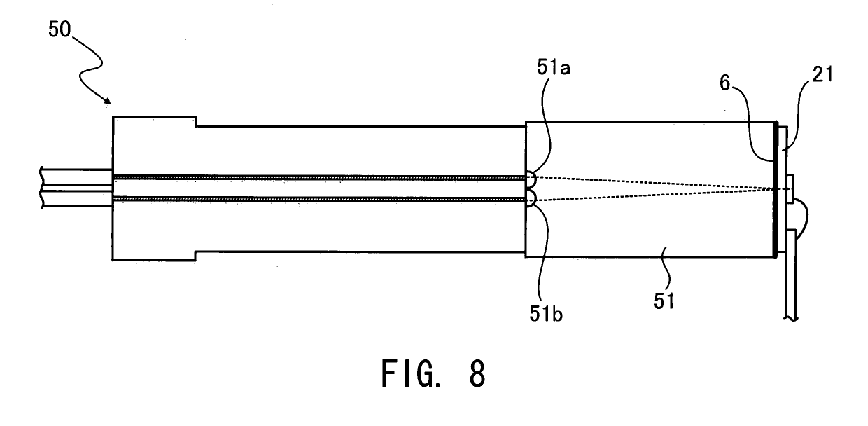

Now, a fifth embodiment of the present invention will be described. FIG. 8 is a side view for describing the feature of the structure of an optical monitor device according to a fifth embodiment of the present invention. Components in FIG. 8 which are the same as those shown in FIGS. 2, 5, and 6 will be marked with the same reference numerals and detailed descriptions of them will be omitted.

An optical monitor device 50 according to the fifth embodiment of the present invention shown in FIG. 8 includes an array lens 51 the thickness of which is almost the same as that of the transparent member 31 shown in FIG. 6 in place of it. A coupler film 6 is formed on the end of the array lens 51 and a PD submount 21 is fixed to the surface of the array lens 51 where the coupler film 6 is formed by the method of, for example, glueing. The optical monitor device 50 according to the fifth embodiment of the present invention differs from the optical monitor device 30 according to the third embodiment of the present invention in these respects. In this case, the direction of lenses 51a and 51b formed in the array lens 51 is opposite to that of the lenses in the above optical monitor device 1, 20, 30, or 40. However, by increasing the thickness of the array lens 51, the same function that is obtained by the array lens 5 in, for example, the optical monitor device 1 can be realized. The rest of the structure and operating principles of the optical monitor device 50 are the same as those of the optical monitor device 30 according to the third embodiment of the present invention. That is to say, an optical signal propagates through the array lens 51 between the lenses 51a and 51b formed in the array lens 51 and the coupler film 6. This is the same with the transparent member 31 shown in FIG. 6. Accordingly, the array lens 51 can be made to function as the transparent member 31 shown in FIG. 6. As a result, the number of parts included in the optical monitor device 50 can be reduced and its structure can be simplified further.

In the optical monitor device 50 according to the fifth embodiment of the present invention, the coupler film 6 is formed on the end of the array lens 51. However, the PD submount 21 on one surface of which the coupler film 6 is formed may be bonded to the array lens 51. Moreover, with an optical monitor device using front incidence type PD elements, the same structure that is used in the optical monitor device 50 according to the fifth embodiment of the present invention can be adopted. In this case, an array lens which reaches the coupler film 6 should be located in the case 9 in, for example, the optical monitor device 1 shown in FIG. 2.

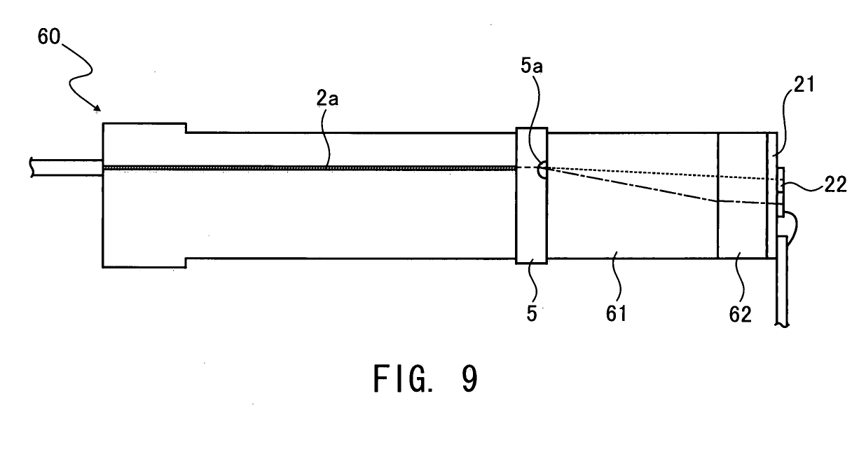

Now, a sixth embodiment of the present invention will be described. FIG. 9 is a side view for describing the feature of the structure of an optical monitor device according to a sixth embodiment of the present invention. Components in FIG. 9 which are the same as those shown in FIGS. 2, 5, and 6 will be marked with the same reference numerals and detailed descriptions of them will be omitted.

In an optical monitor device 60 according to the sixth embodiment of the present invention shown in FIG. 9, a double refraction crystal 61, such as a yttrium vanadate (YVO₄) crystal, is bonded to an array lens 5 by the method of, for example, glueing. In addition, a transparent member 62 is located between the double refraction crystal 61 and a PD submount 21 so that it will bond to the double refraction crystal 61 and the PD submount 21. A transparent solid medium the physical properties of which are the same as or similar to those of, for example, the array lens 5 will be used as the transparent member 62. In the optical monitor device 60, a component which corresponds to the coupler film 6 shown in, for example, FIG. 5 is not formed on the PD submount 21. A total of 24 back incidence type PD elements 22 are arranged on one surface of the PD submount 21. Twelve are arranged on the upper area of one surface of the PD submount 21. The rest are arranged on the lower area of the surface of the PD submount 21. Moreover, in the optical monitor device 60, the equivalent of the output port 3, the output fiber 3a, or the corresponding lens 5b shown in, for example, FIG. 5 is not formed. The optical monitor device 60 according to the sixth embodiment of the present invention differs from the optical monitor device 30 according to the third embodiment of the present invention in these respects. The rest of the structure of the optical monitor device 60 is the same as that of the optical monitor device 30 according to the third embodiment of the present invention.

In the optical monitor device 60 having the above structure, if an input optical signal which is inputted from an input fiber 2a via a lens 5a and which propagates through the double refraction crystal 61 has different polarizations, their optic axes will shift from each other and it will be separated into ordinary and extraordinary rays. Deviation between these optic axes is proportional to the thickness of the double refraction crystal 61. For example, if the above YVO₄ crystal is used as the double refraction crystal 61, then deviation between these optic axes will be about a tenth of the thickness of the crystal. Therefore, if the double refraction crystal 61 is, for example, a YVO₄ crystal with a thickness of 5 mm, then deviation between the optic axes of ordinary and extraordinary rays will be 500 μm. The total of 24 back incidence type PD elements 22 are arranged in an array on the optic axes, respectively, of optical signals which passed through the double refraction crystal 61 according to such deviation between optic axes. As a result, the optical monitor device 60 which functions as a polarization monitor for detecting the intensity of an optical signal with different polarizations can be realized.

With an optical monitor device using front incidence type PD elements, the same structure that is used in the optical monitor device 60 according to the sixth embodiment of the present invention can be adopted. In this case, a double refraction crystal and a transparent member should be located in the case 9 in, for example, the optical monitor device 1 shown in FIG. 2 without the coupler film 6 being formed. In addition, the front incidence type PD elements 7 should be arranged in an array on the optic axes of ordinary and extraordinary rays.

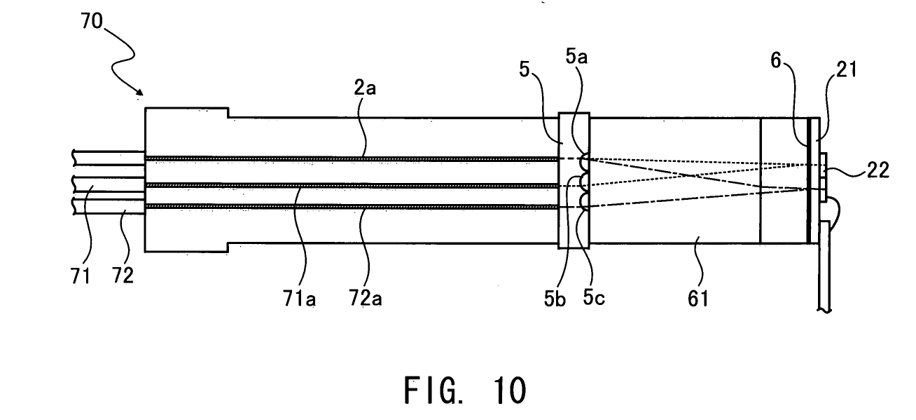

Now, a seventh embodiment of the present invention will be described. FIG. 10 is a side view for describing the feature of the structure of an optical monitor device according to a seventh embodiment of the present invention. Components in FIG. 10 which are the same as those shown in FIGS. 2, 5, 6, and 9 will be marked with the same reference numerals and detailed descriptions of them will be omitted.

In an optical monitor device 70 according to the seventh embodiment of the present invention shown in FIG. 10, a coupler film 6 is formed on one surface of a PD submount 21. Moreover, the optical monitor device 70 includes first and second output ports 71 and 72 and first and second output fibers 71a and 72a. Lenses 5b and 5c are formed in an array lens 5. Their positions correspond to the first and second output fibers 71a and 72a respectively. The optical monitor device 70 differs from the optical monitor device 60 according to the sixth embodiment of the present invention in these respects. The rest of the structure of the optical monitor device 70 is the same as that of the optical monitor device 60 according to the sixth embodiment of the present invention.

In the optical monitor device 70, if an optical signal which is inputted from an input fiber 2a via a lens 5a and which propagates through a double refraction crystal 61 has different polarizations, it will be separated into ordinary and extraordinary rays. The ordinary ray is reflected by the coupler film 6 and a reflected ray will be coupled to the first output fiber 71a via the lens 5b. The extraordinary ray is reflected by the coupler film 6 and a reflected ray will be coupled to the second output fiber 72 a via the lens 5c. Part of the ordinary ray which passes through the coupler film 6 is inputted to a back incidence type PD element 22 located on its optic axis and its intensity is detected. Similarly, part of the extraordinary ray which passes through the coupler film 6 is inputted to a back incidence type PD element 22 located on its optic axis and its intensity is detected. As a result, the optical monitor device 70 which can not only detect the intensity of an optical signal with different polarizations but also separate polarizations can be realized.

With an optical monitor device using front incidence type PD elements, the same structure that is used in the optical monitor device 70 according to the seventh embodiment of the present invention can be adopted. In this case, an additional output port corresponding to the above second output port 72 and additional output fibers corresponding to the above second output fibers 72a should be formed first in, for example, the optical monitor device 1 shown in FIG. 2. Then a double refraction crystal should be located in the case 9 and the front incidence type PD elements 7 should be arranged in an array on the optic axes of ordinary and extraordinary rays.

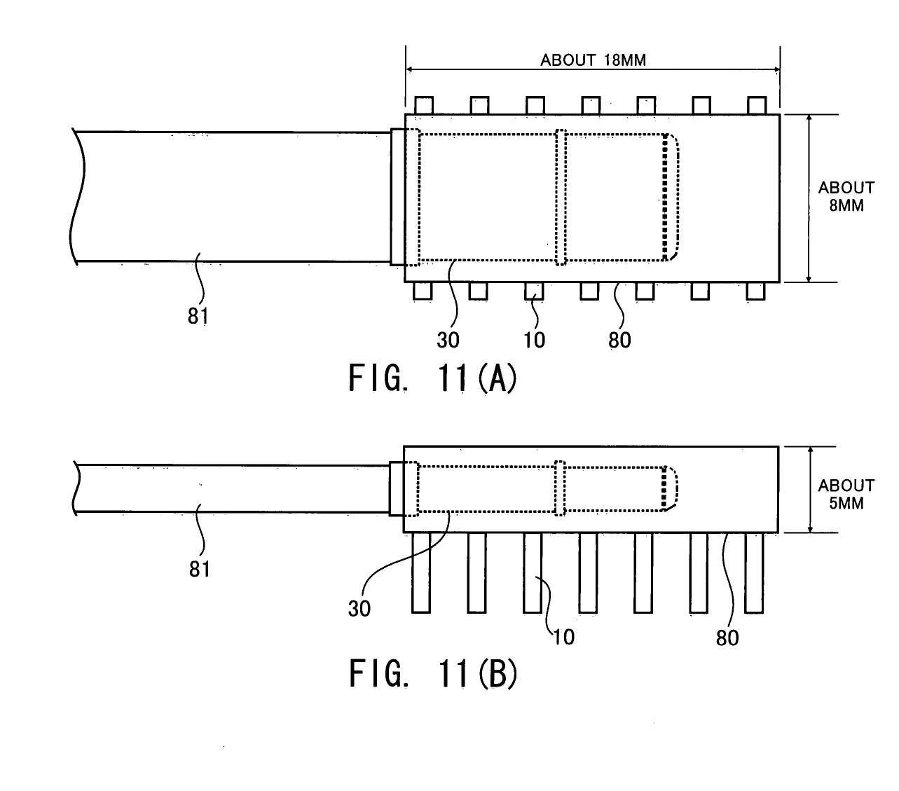

Each of the optical monitor devices 1, 20, 30, 40, 50, 60, and 70 according to the above first through seventh embodiments, respectively, is housed in a package. FIGS. 11(A) and 11(B) are views showing an example of how to house an optical monitor device in a package. FIG. 11(A) is a plan of a feature. FIG. 11(B) is a side view of the feature. In the case of, for example, the optical monitor device 30, the back incidence type PD elements 22 shown in FIG. 6 are sealed and then almost the entire optical monitor device 30 is housed in a package 80 made of metal or plastic. Various kinds of metals, such as aluminum, can be used for making the package 80. Plastic, such as an epoxy resin or a polyphenylene sulfide (PPS) resin, can also be used for making the package 80. A tape fiber 81 into which the input port 2 and output port 3 shown in FIG. 6 are united by the use of appropriate plastic and electric terminals 10 are drawn from the package 80 to the outside. The package 80 may measure, for example, about 8 mm by about 18 by about 5 high. The other optical monitor devices 1, 20, 40, 50, 60, and 70 are housed in the same way. These are finally mounted on a printed circuit board or the like and can be used in an optical transmission unit or the like.

As has been described in the foregoing, in the present invention a plurality of fibers and a plurality of lenses are arranged in an array, an optical signal is inputted via any lens, part of the optical signal which passes through a coupler film is detected by a photodetector, and the rest of the optical signal which does not pass through the coupler film is reflected into another lens. As a result, a reflection and loop back structure is realized. In this reflection and loop back structure, a plurality of input optical signals can be monitored and each of them is reflected accurately by a coupler film and is outputted. Therefore, a small optical monitor device can be obtained.

Furthermore, many of the members used in the optical monitor device according to the present invention are generally available. Accordingly, the costs of an optical monitor device can be reduced.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An optical monitor device for detecting the intensity of an optical signal propagating through a fiber, the device comprising:
a plurality of fibers which are arranged in an array and through which optical signals propagate;
lenses arranged in an array on the optic axes of optical signals propagating through the plurality of fibers;
a coupler film for transmitting part of an optical signal inputted via any one of the lenses and for reflecting the rest of the optical signal into another lens; and
photodetectors arranged on the optic axes of optical signals which pass through the coupler film.

2. The optical monitor device according to claim 1, wherein the optical path of an optical signal which is inputted to and reflected from the coupler film is adjusted by a position on the surface of each of the lenses where an optical signal is inputted from the fiber to the lens and by a position on the surface of each of the lenses where an optical signal is outputted from the lens to the fiber.

3. The optical monitor device according to claim 1, wherein the photodetectors are front incidence type photodiode elements arranged at a constant distance from a member on which the coupler film is formed.

4. The optical monitor device according to claim 1, wherein the photodetectors are back incidence type photodiode elements arranged on one surface of a member on the other surface of which the coupler film is formed.

5. The optical monitor device according to claim 4, wherein the back incidence type photodiode elements are sealed by the use of resin.

6. The optical monitor device according to claim 1, wherein an area between the lenses and the coupler film through which optical signals propagate is occupied by a transparent member.

7. The optical monitor device according to claim 6, wherein the coupler film is formed integrally on the transparent member.

8. The optical monitor device according to claim 1, wherein optical signals to be received by the photodetectors can be selected from optical signals which pass through the coupler film by changing the distance from the coupler film to the photodetectors.

9. The optical monitor device according to claim 1, wherein the coupler film is formed on one surface of an array lens in the other surface of which the lenses are formed so that optical signals will propagate through the array lens.

10. An optical monitor device for detecting the intensity of an optical signal with different polarizations propagating through a fiber, the device comprising:
a plurality of fibers which are arranged in an array and through which optical signals propagate;
lenses arranged in an array on the optic axes of optical signals propagating through the plurality of fibers;
a double refraction crystal for transmitting an optical signal inputted via each of the lenses and for separating the optical signal into an ordinary ray and an extraordinary ray; and
photodetectors arranged on the optic axes of the ordinary ray and the extraordinary ray which propagate through the double refraction crystal.

11. The optical monitor device according to claim 10, further comprising a coupler film located between the double refraction crystal and the photodetectors for transmitting part of an optical signal inputted via any one of the lenses and for reflecting the rest of the optical signal into another lens.

12. The optical monitor device according to claim 1, wherein the photodetectors are mounted on one surface of a submount, further wherein a first electrode is formed on each of the photodetectors and a second electrode is formed on the other surface of the submount.

13. The optical monitor device according to claim 1, wherein the photodetectors are mounted on one surface of a submount, further wherein a first electrode and a second electrode are formed on each of the photodetectors.
